(19) United States
(12) Patent Application Publication
(10) Pub. No.: US 2025/0063332 A1
(43) Pub. Date: Feb. 20, 2025

(54) EMERGENCY MANAGEMENT SYSTEM

(71) Applicant: Alarm.com Incorporated, Tysons, VA (US)

(72) Inventors: Adam Brandfass, Pittsburgh, PA (US); Alicia Burns, Reston, VA (US); Michael Kelly, Washington, DC (US)

(21) Appl. No.: 18/786,897

(22) Filed: Jul. 29, 2024

Related U.S. Application Data
(60) Provisional application No. 63/532,754, filed on Aug. 15, 2023.

(51) Int. Cl. H04W 4/90; H04W 4/029

(52) U.S. Cl. CPC H04W 4/90; H04W 4/029

(57) ABSTRACT

Methods, systems, and apparatus, including computer programs encoded on computer storage media, for an emergency management system. One of the methods includes receiving, for each of a plurality of properties in a geographic region and during an emergency in a first subregion of the geographic region having a first property, sensor data from sensors located at the respective property. The plurality of properties includes the first property and a second property. A risk score is generated for a second geographic region that indicates a likelihood that properties will be impacted by the emergency. In response, the method determines whether the risk score satisfies a score threshold, the method proceeds by determines a safe zone that indicates a physical location at which a risk of injury is reduced and presents a pathway on a map displayed on a user device to the safe zone.

### CROSS-REFERENCE TO RELATED APPLICATION

This application claims the benefit of U.S. Provisional Application No. 63/532,754, filed Aug. 15, 2023, and titled “Emergency Management System,” which is incorporated by reference.

### BACKGROUND

Monitoring devices and sensors can be dispersed at various locations at a property, such as a home or commercial business. These devices and sensors can have distinct functions at different locations of the property. Some sensors at a property offer different types of monitoring and control functionality. The control functionality afforded by these sensors and devices can be leveraged to obtain information about items at respective properties that are located in certain areas or geographic locations.

### SUMMARY

A system can alert users of a local emergency in a given geographic region and generate a graphical representation of a pathway to a safe zone, e.g., outside of the geographic region or at another appropriate location. The system collects and analyzes data for the geographic region. Given the larger quantity of data the system can analyze, the system can perform computational resource optimizations as described in more detail below. Such data can include data for, for example, flood, wind, property, damage, heat or cold, occupancy status, activity status, or a combination of two or more of these.

In some systems, when managing emergencies, local authorities, e.g., first responders, rely on weather reports and emergency calls, such as 911 calls or other distress signals from at-risk individuals. As a result, assisting individuals in the emergency-affected area is achieved on an ad-hoc basis.

In contrast, the system can aggregate data automatically and consistently for the affected area. For instance, the system allows for rapid, automatic, and consistent aggregation of thousands of data points into a uniform dataset so that local authorities and first responders have real-time information on priority extractions or other types of assistance. As a result of the aggregation of the data, the system can reduce computational resource usage by communicating with subsystems, e.g., property monitoring systems, from which the system is likely to receive the most network traffic data, e.g., for higher priority risks, before communicating with subsystems from which the system is likely to receive less network traffic data, e.g., for lower priority risks. This can reduce a number of times that the first type of subsystem actually communicates with the system.

In some implementations, the data collected by the system is directly received from devices operated by individuals that have access to the system. In some implementations, the collected data is acquired automatically should individuals not be able to communicate the data safely, or due to incapacitation of the individual(s) such as personal injury, or a lack of access to electronic communication devices or networks.

In general, one innovative aspect of the subject matter described in this specification can be embodied in methods that include the actions of receiving, for each of a plurality of properties in a geographic region and during an emergency in at least a first subregion of the geographic region that includes a first property, sensor data from one or more sensors located at the respective property. The plurality of properties include the first property in the first subregion of the geographic region and a second property in a second, different subregion of the geographic region. The actions include generating, using the sensor data received from the sensors located at the pluralities of properties, a risk score i) for at least a second, different subregion of the geographic region ii) that indicates a likelihood that properties in the second, different subregion of the geographic region will be impacted by the emergency. In response to determining that the risk score satisfies a score threshold, the actions include determining, using sensor data received from the one or more sensors at the second property, whether the second property is likely occupied by a person. In response to determining that the second property is likely occupied by a person, the actions continue by determining, using at least some of the sensor data and a type of the emergency, a safe zone for the second property that indicates a physical location at which a risk of injury caused by the emergency is likely less than another location within a threshold distance of the second property. The actions include determining, for presentation on a user interface, a pathway from a predicted location of the person to the safe zone. The actions include providing, to a device for presentation in the user interface, instructions to cause the device to present, in the user interface, a map of at least some of the geographic region including a) the predicted location of the person and the safe zone and b) the pathway from the predicted location of the person to a safe zone.

In general, one innovative aspect of the subject matter described in this specification can be embodied in methods that include the actions of receiving, by a system, for each of a plurality of properties in a geographic region and during an emergency in at least a first subregion of the geographic region that includes a first property, sensor data from one or more sensors located at the respective property. The plurality of properties include the first property in the first subregion of the geographic region and a second property in a second, and different subregion of the geographic region. The actions include receiving, from a first subsystem for the first property, a first request for assistance. The action includes receiving, from a second subsystem for the second property, a second request for assistance. The actions include determining, using first sensor data for the first subregion of the geographic region and second sensor data for the second, different subregion of the geographic region, a priority ranking in which the first request and the second request should be addressed. The actions include providing, to a device, instructions to cause the device to present the priority ranking in which the first request and the second request should be addressed.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method may include determining an updated predicted location of the person, and determining whether the updated predicted location satisfies a distance threshold for the second property. In response to determining that the updated predicted location does not satisfy the distance threshold for the second property, the method can include changing a frequency of analysis of sensor data for the second property.

In some implementations, the method may include determining whether the updated predicted location satisfies the distance threshold for the second property includes determining whether the second property is unoccupied. The method can include changing the frequency of analysis of sensor data for the second property is responsive to determining that the second property is unoccupied.

In some implementations, determining the safe zone can include determining the safe zone that is outside of the geographic region.

In some implementation, determining the safe zone can include determining the safe zone that is in another subregion of the geographic region than the second, different subregion.

In some implementations, receiving the sensor data can include receiving, for at least one property in a third, different subregion of the geographic region, at least some of the sensor data. Determining the safe zone can include determining the safe zone in the third, different subregion of the geographic region.

In some implementations, the method may include receiving the sensor data includes receiving the sensor data for one or more properties a) in the first subregion of the geographic region and b) that do not include the second property.

In some implementations, the method can include generating the risk score for the second, different subregion of the geographic region includes generating the risk score for the second property. Determining whether the second property is likely occupied by the person can be responsive to determining that the risk score for the second property satisfies the score threshold.

In some implementations, the method includes generating, for a third, different subregion of the geographic region, a second risk score. The method can include determining that the second risk score does not satisfy the score threshold. Determining the safe zone can include determining the safe zone in the third, different subregion of the geographic region in response to determining that the second risk score does not satisfy the score threshold.

In some implementations, the method includes determining, for one or more subregions of the geographic region and using the priority ranking, a frequency with which to analyze sensor data for the respective subregion of the geographic region. The method can include analyzing, for the one or more subregions of the geographic region and using the frequency, sensor data received from one or more properties in the respective region.

In some implementations, the method includes determining, for one or more subregions of the geographic region and using the priority ranking, a frequency with which to request sensor data for the respective subregion of the geographic region. The method can include communicating with one or more properties in a subregion of the one or more subregions using the frequency.

In some implementations, the method includes determining that a third property in the geographic region is unoccupied. The method can include determining to skip communicating with the third property in response to determining that the third property in the geographic region is unoccupied.

In some implementations, the first sensor data for the first subregion of the geographic region includes sensor data received from one or more first sensors at properties in the first subregion other than the first property. At least some of the second sensor data can be received from one or more second sensors at the second property.

In some implementations, providing the instructions includes providing the instructions to cause the device to generate, in a user interface, a representation on a map of the priority ranking in which the first request and the second request should be addressed.

In some implementations, the instructions cause the device to present a first user interface element for the first property or the second property that is occupied and a second, different user interface element for a third property in the geographic region that is unoccupied.

In some implementations, determining the priority ranking in which the first request and the second request should be addressed uses the first sensor data, the second sensor data, a first assistance type for the first request, and a second assistance type for the second request.

In some implementations, the method includes determining, using data for the first request and the priority ranking, to provide, to another device for the first request, second instructions for addressing the first request. The method can include providing, to the other device, the second instructions for addressing the first request. The instructions can include providing the instructions to cause the device to present the priority ranking that includes data indicating that instructions for the first request were provided to the other device.

In some implementations, providing the second instructions for addressing the first request includes determining, using at least some of the sensor data and a type of the emergency, a safe zone for the first property that indicates a physical location at which a risk of injury caused by the emergency is likely less than another location within a threshold distance of the first property. The operations can include determining, for presentation on a user interface, a pathway from a predicted location of a person for the first request to the safe zone. The operations can include providing, to the other device for presentation in the user interface, the instructions to cause the other device to present, in the user interface, a map of at least some of the geographic region including a) the predicted location of the person and the safe zone and b) the pathway from the predicted location of the person to a safe zone.

The subject matter described in this specification can be implemented in various implementations and may result in one or more of the following advantages. In some implementations, the systems and methods described in this specification can reduce computer resource usages. For instance, by providing instructions to cause presentation of a map in a user interface that includes a pathway from a predicted location to a safe zone, a system can stop monitoring sensor data for the predicted location, reducing resource usage, e.g., processor, memory, and network resource usage.

By determining a priority ranking in which the first request and the second request should be addressed, a system can reduce an amount of network traffic; an amount of data analyzed; a frequency with which data is analyzed, requested, or both; or a combination of these, required for updates on a person's status, a property's status, or a combination of both.

In some implementations, the systems and methods described in this specification can reduce risk, e.g., for people in an emergency situation. For example, the system enables real-time assessment of risk associated with individuals and enables first responders to identify, with greater certainty, individuals at risk. The system can enable first responders to save people at higher risk sooner than those at lower risk, e.g., by having a reliable source of real-time data about an active threat. In some implementations, the systems and methods described in this specification can save time, can reduce human error, or both, by automatically aggregating and prioritizing the data. By automating aggregation and prioritization of the data, the system and method can enable better outcomes for people at risk, enable more efficient deployment and utilization of first responders and related emergency response personnel, or a combination of both.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a schematic view of an environment for utilizing sensors to monitor an emergency related to one or more properties.

FIG. 2 depicts an example of a graphical user interface for a geographic region.

FIG. 3 is an example of a geographic region that has one or more properties.

FIG. 4 depicts an example flow chart indicating a process for causing presentation of a user interface.

FIG. 5 depicts an example flow chart indicating a process for causing presentation of a priority ranking.

FIG. 6 shows a diagram illustrating an example property monitoring system.

Like reference symbols in the various drawings indicate like elements.

### DETAILED DESCRIPTION

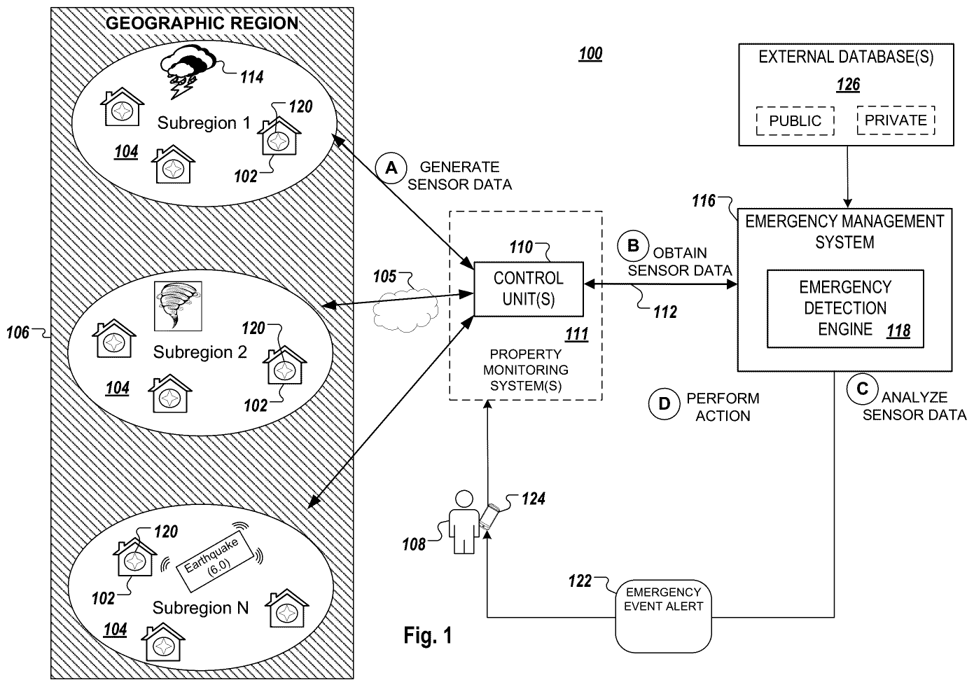

FIG. 1 is a schematic view of an environment 100 for utilizing sensors to monitor an emergency related to multiple properties. The environment 100 includes an emergency management system 116 that communicates with one or more control units 110. The control units 110 can be for respective properties 102 and can be physically located at the respective property or remote from the respective property. Given the large amount of data the emergency management system 116 receives from the control units 110, the emergency management system 116 can control communications with the various control units 110, e.g., to reduce an amount of computational resources required to communicate with the control units. In some examples, the emergency management system 116 can communicate with one or more user devices 124 and can use various data to control communications with the user devices 124. The user devices 124 can include devices that are part of a first responder system.

The environment 100 includes one or more control units 110, and one or more sensors 120 located at a given property 102. The one or more sensors 120 are coupled to control unit 110, e.g., via a network 105. The sensors 120 can be any appropriate types of sensors, e.g., motion sensors, pressure sensors, or cameras to name a few examples.

The control unit 110 can be located at the property 102 or at a remote location relative to a location of the property 102. In some implementations, a control unit 110 is located separate from a respective property 102, while the sensors 120 are at the respective property 102.

The sensors 120 can transmit signals that encode sensor data 112 for the property 102. In some implementations, the sensors 120 may include, for example, various types of signal processing sensors or related wireless sensors that are resilient to certain weather conditions that may be present at the property 102. The sensors 120 communicate with the emergency management system 116. For instance, a sensor 120 can provide sensor data to the control unit 110. The control unit 110 can then provide the sensor data to the emergency management system 116.

The emergency management system 116 can manage data for one or more subregions 1-N 104. The one or more subregions 104 can be predetermined, dynamically determined, e.g., by the emergency management system 116, or a combination of both. For instance, one or more of the subregions 104 can determined dynamically for an emergency for which the emergency management system 116 processes data. In some examples, a user 108 can use the emergency management system 116 to manually define a subregion 104. In some examples, the emergency management system 116 can automatically the subregion 104 based on existing data and information about the properties 102, e.g., retrieved from corresponding property monitoring systems 111.

As described in more detail below, each of the one or more subregions 104 can be located within a geographic region 106. For example, the emergency management system 116 can determine that a potential emergency 114 is likely to impact one or more properties in the geographic region 106. In response, the emergency management system 116 can determine corresponding subregions 104 within the geographic region 106 to which each property is assigned.

In general, when an emergency 114 occurs, a record may be logged in one or more external databases 126. The more external database(s) 126 may be public or private. For example, a U.S. government services (USGS) database may record characteristics of various types of events, including natural disasters, weather systems, and other public threats. In some instances, the database 126 maintains information about emergencies 114, such as hurricanes, tropical storms, tornados, or earthquakes. For example, the recorded information can specify a geographic location of the emergency 114 and attributes of the emergency, such as magnitudes for earthquakes or temperature, wind speed, and precipitation for tropical storms, hurricanes, and tornados.

When the emergency is in a region that can have an earthquake or a potential earthquake, the one or more sensors 120 can include accelerometers that indicate shaking, and glass break sensors that indicate damage to windows and doors. The sensors 120 can include contact sensors that indicate that doors/windows were thrown open or destroyed; flood sensors that indicate broken water pipes; and gas/carbon monoxide sensors that may indicate broken gas lines. The one or more sensors 120 can include smoke detectors that indicate a fire, and electricity/power sensors that indicate loss of power. Each sensor 120 can be associated with various types of devices that are located at the property 102. For example, one of the sensors 120 can include a digital camera or another type of motion sensor. The one or more sensors 120 can be an audio sensor, microphone, a temperature sensor, air quality sensor, and the like.

The emergency management system 116 can receive data from the one or more external databases 126 that indicates a potential emergency. The data can indicate a likelihood of severe weather in the geographic region 106 or an area within a threshold distance from the geographic region. In some examples, in response to receiving the data, the emergency management system 116 can determine whether to perform one or more actions for an emergency.

The emergency management system 116 can access one or more settings to determine the default action. The emergency management system 116 can access the settings in response to confirming that the emergency 114 caused, or is likely to cause, an emergency situation at the property 102. The emergency situation can be potential damage to an item at the property 102, an emergency for a person at the property 102, or a combination of both. For example, the emergency management system 116 can reference sensor data 112 generated by sensors 120 to first confirm that damage has occurred to items at the property 102. In some examples, an emergency for a person at the property can include damage or potential damage to a building on the property 102, e.g., a home.

Emergency management system 116 includes an emergency detection engine 118 that detects an occurrence of a potential emergency that affects a particular zone in the geographic region 106. The emergency management system 116 can access data from database 126 and provide the data to the emergency detection engine 118. The emergency detection engine 118 can analyze the data. In response to analyzing the data, the emergency detection engine 118 may detect that a property 102 is in a first subregion 104 of a geographic region 106 that is affected by an emergency 114. In some implementations, if sensors 120 cannot be used to confirm that a likelihood of a potential emergency 114 satisfies a threshold likelihood, then emergency management system 116 can determine to skip performing an action for the emergency, e.g., without first obtaining user confirmation to perform the action.

The emergency management system 116 obtains sensor data 112 from one or more sensors 120 positioned at the locations of a property 102 in the subregion 104. The emergency management system 116 can use the emergency detection engine 118 to analyze the obtained sensor data 112 to determine a likelihood that an emergency 114 occurred at the property 102, whether the likelihood satisfies a threshold likelihood, or both. For example, the emergency management system 116 analyzes the sensor data 112 encoded in signals received from a control unit 110 to determine a status or condition of an item at the property 102. The item can be a known household or commercial property item, such as windows, doors, vehicles, physical structures, mobile structures, or other related items typically located at a property. The emergency management system 116 performs various functions relating to analyzing or monitoring image data, other sensor data, or both, included in the sensor data 112.

The emergency management system 116 uses the emergency detection engine 118 to process the sensor data 112 to determine whether an emergency has adversely affected, will adversely affect, or is presently adversely affecting, a property 102. In some implementations, the emergency detection engine 118 is an example machine-learning engine that is configured to process input data, e.g., from database 126, the sensor data 112, or a combination of both. The data obtained from database 126 may describe events (e.g., weather systems or fire) having potential to adversely affect the property 102, e.g., items located at the property 102. The emergency detection engine 118 can include a predictive model, e.g., an artificial neural network, trained to predict that a particular event will adversely affect property 102, e.g., will cause an emergency at the property 102.

In response to determining that the likelihood of the emergency 114 at the property 102, or within a threshold distance of the property 102, satisfies the likelihood threshold, the emergency management system 116 can obtain sensor data 112 from a control unit 110 for the property 102, generate an alert 122 for the property, or a combination of both. In some examples, the emergency management system 116 can obtain sensor data 112 from control units 110 for properties within a threshold distance of the property 102. For example, the alert 122 can state that “USGS reported an earthquake, magnitude 7.5, which may have affected your locations in [Zone Name]. Sensors and video data confirm damage to your property locations within [Zone Name].”

In some examples, the alert 122 can include potential mitigation factors. The mitigation factors can reduce a likelihood of one or more adverse events, can reduce an amount of communication between the emergency management system 116 and the corresponding control unit 110, or a combination of both. For instance, the alert 122 can indicate a safe zone for one or more people at the property to go to in order to reduce a likelihood of harm to the people given the emergency.

FIG. 1 includes stages A through D, which represent a flow of data. In stage (A), each of the one or more sensors 120 generate sensor data 112 such as video data and audio data that describe different types of sensed activity at the property 102. In some implementations, the control unit 110 (e.g., located at the property 102) collects and sends the sensor data 112 (e.g., captured by the sensors 120 at the property 102) to the emergency management system 116 for processing and analysis.

In stage (B), the emergency management system 116 receives the sensor data 112 from the control unit 110. The emergency management system 116 can communicate electronically with the control unit 110 using any appropriate type of network, or other appropriate type of connection.

In stage (C), the emergency management system 116 analyzes the sensor data 112 for the property. In some examples, the emergency management system can analyze other property data for the property 102, e.g., received from the control unit 110 for the property 102. The other property data can include floor plans, or elevation data. As indicated above, the emergency management system 116 analyzes the sensor data 112 to determine whether items at a property 102 have been, or might be, damaged or otherwise adversely affected by emergency 114.

Using a result of the data analysis, in stage (D), the emergency management system 116 performs various actions. In some cases, the emergency management system 116 performs the various actions as a default function based on the predefined settings. In some implementations, the emergency management system 116 performs the various actions in response to receiving user commands from user device 124. For example, the emergency management system 116 can initiate sensor monitoring, send notifications or alerts to user device 124, receive response commands from user device 124, and one or more properties 102 in the subregions 104.

Though the stages are described above in order of (A) through (D), other sequencings are possible including performance of some stages concurrently, some stages multiple times, or a combination of both. For example, in some implementations, the emergency management system 116 may receive first sensor data 112 from the control unit 110, analyze the first sensor data 112, and then receive second sensor data 112, e.g., after the analysis or at least partially during the analysis.

Advantageously, the environment 100 can improve the effectiveness of emergency response during, after, or both, an emergency, e.g., a natural disaster. The environment 100 obtains data related to damage, potential damage, or both to a property (e.g., flood detection, wind/property damage determined by cameras, extreme heat/cold determined by temperature sensors, etc.). The environment 100 obtains data related to occupancy status (how many people are in the property), and activity status (i.e., do sensors 120 detect movement within the property 102). The environment 100 obtains data related to allow for rapid, automatic, consistently updating collection of thousands of data points in a uniform dataset that does not rely upon the aggregation and analysis of emergency calls.

The environment 100 is an example of a system implemented as computer programs on one or more computers in one or more locations, in which the systems, components, and techniques described in this specification are implemented. The user device(s) 124 can include personal computers, mobile communication devices, and other devices that can send and receive data over a network (optionally including the network 105). One or more networks, such as a local area network (“LAN”), wide area network (“WAN”), the Internet, or a combination thereof, connects the user device(s) 124, the control unit 110, the emergency management system 116, and the external databases 126. In some examples, the user device 124 is an electronic home assistant or a smart speaker. The components of the control unit 110, the emergency management system 116, or both, can use a single server computer or multiple server computers operating in conjunction with one another, including, for example, a set of remote computers deployed as a cloud computing service.

The emergency management system 116 can include several different functional components, including the emergency detection engine 118. The emergency detection engine 118 can include one or more data processing apparatuses, can be implemented in code, or a combination of both. For instance, emergency detection engine 118 can include one or more data processors and instructions that cause the one or more data processors to perform the operations discussed herein.

The various functional components of the environment 100 can be installed on one or more computers as separate functional components or as different modules of a same functional component. For example, the emergency management system and the property monitoring systems 111 of the environment 100 can be implemented as computer programs installed on one or more computers in one or more locations that are coupled to each through a network. In cloud-based systems for example, these components can be implemented by individual computing nodes of a distributed computing system.

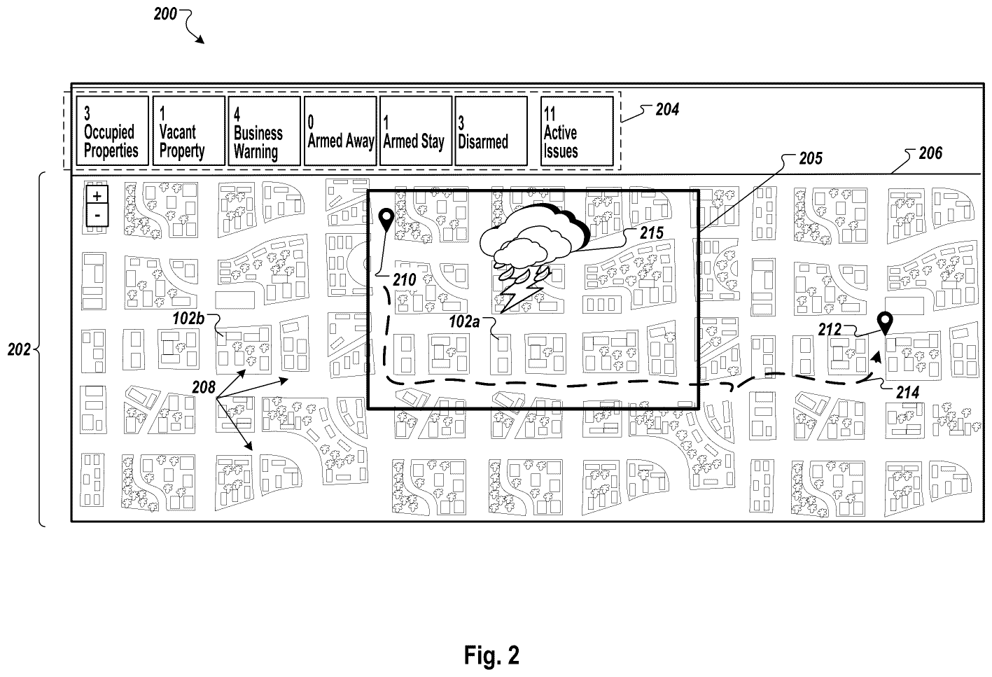

FIG. 2 depicts an example of a graphical user interface (GUI) 200 for a geographic region 202. The geographic region 202 can be the geographic region 106 shown in FIG. 1. The GUI 200 can present information about the geographic region using a status portion 204, a map portion 206, or both. The information can indicate a route for a person to take to reduce a likelihood of injury by an emergency, locations of one or more events to address for an emergency, or a combination of both. The events can be people in need of assistance, damage caused to a building or another object, or a combination of these.

The GUI 200 has a status portion 204 that provides information on one or more properties in the geographic region 202. The status portion 204, e.g., with text, graphics, or a combination of both, can indicate the status of properties, e.g., properties 102, within the subregion 205, utilizing sensor data. For instance, an emergency management system, e.g., the emergency management system 116, can analyze sensor data from systems for various properties in the geographic region 202. The emergency management system can use a result of the analysis to determine a status for one or more of the properties. The emergency management system can provide data about the status for generation of the GUI 200. For instance, the emergency management system can provide the data to an application executing on a mobile device. The application can be any appropriate application, such as a web browser or an emergency assistance application. The application can use the data, e.g., instructions, to generate the GUI 200.

The status portion 204 indicates a status or condition of a person, property, object, or a combination of these, within one or more of the properties. The status portion 204 can be for all properties in the geographic region 202 or within a subregion 205, e.g., the subregion 205.

The status portion 204 can display any appropriate information. The status portion 204 can be configured to display information indicating a number of properties that are closed or open in the subregion 205. The status portion 204 can display warnings that have been generated by a property monitoring system connected to a property. The status portion 204 can indicate whether a security system at the property is armed or disarmed. The status portion 204 can indicate whether certain entry points are open or closed, the number, type, or both, of active issues that are affecting the property, or a combination of these. The status portion 204 can display whether a property is occupied or unoccupied. In some examples, the status portion 204 can indicate whether a property was affected by an emergency 215, e.g., the emergency 114, or unaffected by the emergency 215. For example, if the emergency 215 is a forest fire, the status portion 204 can indicate whether a given property in the subregion 205 is directly affected by the forest fire or might be directly affected by the forest fire.

The GUI 200 includes at least a map portion 206 that provides information on the geographic region 202. The map portion 206 may include a plurality of residential blocks 208. Each block 208 can have one or more properties 102.

The GUI 200 is configured to depict information about an emergency 215 on the map portion 206. The information about the emergency 215 can include information about one or more emergencies 215 or a combination of events that defines a single emergency, e.g., flooding and downed power lines caused by a storm. The emergency 215 illustrated on the GUI 200 corresponds to an actual emergency occurring at a physical location in the geographic region 202. In some examples, the emergency 215 can have a threshold likelihood of affecting at least a portion of the geographic region 202.

In some examples, the GUI 200 can present a pathway from one location to another. The use of the GUI 200 to present the pathway can reduce risk of a person at the first location being affected by the emergency, can reduce an amount of network communications between sensors at the first location and an emergency management system, or both. The emergency management system can

The emergency management system can use sensor data from sensors at one or more properties to detect various events. The properties can be properties that have property monitoring systems or do not have property monitoring systems. In some examples, the emergency management system receives sensor data from sensors at some of the properties. In some examples, the emergency management system might not receive sensor data from sensors at some of the properties. This can enable the emergency management system to reduce risk, increase safety, or both, e.g., when the emergency management system can determine that an event likely occurred at a property for which the emergency management system does not have sensor data generated by a sensor at the property. The emergency management system can use sensor data from properties within a threshold distance of such a property to determine whether an event is likely at the property. In some examples, the emergency management system can use sensor data from another property within a threshold distance of such a property to determine that an event actually occurred, e.g., when a camera at the other property captures images depicting the event at the property. In this way, the emergency management system can improve an accuracy of information about an emergency, and events associated with that emergency, when the emergency management system might otherwise have incomplete data for all properties in the geographic region 202.

The map portion 206 can depict a first location 210, e.g., inside the subregion 205. For instance, the emergency management system can determine that an emergency 215 has a threshold likelihood of affecting the subregion 205 in the geographic region 202 and does not have the threshold likelihood of affecting the other subregions of the geographic region 202. The emergency management system can determine that an event occurred at the first location 210, e.g., that a person is likely located at the first location 210.

The map portion can depict a second location 212, outside of the subregion 205. The emergency management system can determine that second location 212 is in a subregion without the threshold likelihood of being affected by the emergency 215. The emergency management system might determine that the second location 212 is at least a first threshold distance from the subregion 205, a second threshold distance from the emergency 215, or a combination of both.

The emergency management system can determine a pathway 214 from the first location 210 to the second location 212. Other pathways can be determined, and it is understood that the pathway 214 is an exemplary illustration. The emergency management system can determine the pathway 214 to reduce a risk to a person navigating the pathway 214 given the emergency 215. For instance, the emergency management system can use data from the sensors for the properties in the geographic region 202 to determine the pathway 214. In this way, the emergency management system can determine a pathway 214 that is likely more accurate than if the emergency management system generated the pathway 214 using only data from external databases, e.g., government or news data, only data from a sensor at a property that includes or is within a threshold distance of the first location 210, or a combination of both.

By determining the pathway 214 using sensor data from multiple properties 102 in the geographic region 202, the emergency management system can reduce computational resource usage. For instance, instead of providing an initial pathway 214 generated using different, less, or both, data, e.g., for a single property, the emergency management system can determine the pathway 214 away from the subregion 205 affected by the emergency 215, which pathway is less likely to change, and require updates, by using sensor data from multiple properties in the geographic region 202. The emergency management system can use sensor data from all properties in the subregion 205, or from a threshold amount of properties in the subregion 205. In some examples, the emergency management system can use the first location 210 to determine the properties for which the emergency management system should analyze data to determine the pathway 214. As a result, the emergency management system can use sensor data for a subset of properties, reducing an amount of sensor data analyzed.

As part of the pathway 214 determination, the emergency management system can compare data, received from the sensor(s) 120, against one or more criteria that indicate high risk scenarios. For example, criteria can include a risk score threshold, a current risk score, a rate of change of the risk score, or a combination of these. A risk score can indicate a likelihood that the property will be impacted by the emergency. The emergency management system can generate risk scores for at least some individual properties in the geographic region 202, for groups of properties in the geographic region 202, or a combination of both. The emergency management system can generate risk scores for groups of properties when the emergency management system does not have sensor data for all individual properties in a group. The properties in a group can be within a threshold distance of each other. For example, exposure of the property 102 at a given temperature for a threshold number of hours, can indicates a high risk of frost bite or heat stroke. In some examples, a detected wind speed at a threshold velocity, can indicate a high risk of damage to a structure, such as a house, located at the property 102. In some examples, a threshold rate of water ingress, or threshold water height, can indicate a high-risk score of drowning. For example, flood sensor could indicate rising water level. In some examples, a threshold rate of temperature increase can indicate a proximity and speed of heat from a forest fire proximate the property 102.

In some implementations, the emergency management system can use sensor data from the properties to determine a priority in which an event should be addressed. For instance, when the emergency 215 is extreme weather, e.g., cold weather, the temperature at a number of properties in the subregion 205 can satisfy a temperature threshold, e.g., indicating how cold the property is. The emergency management system can determine that a sensor at the property 102a indicates a temperature change at a threshold rate different from a change at other properties, such as two standard deviations above other properties, e.g., the property 102b. The property 102a that outlies by two standard deviations can indicate a higher level of damage to the property 102a, a high risk to people at the property 102a, or both. Given the different temperature changes, if the emergency management system detects emergency events at both of the properties 102a-b, the emergency management system can assign a higher priority to the property 102a with the higher temperature change than the property 102b that has a temperature change more similar to the other properties in the geographic region 202.

The GUI 200 can present information about the properties, such as priorities for events at the properties. For instance, the map region 206 can depict information indicating that there are emergency events at both of the properties 102a-b and that the emergency event at the property 102a has a higher priority than the emergency event at the other property 102b. In some examples, the information can indicate that the property 102a is occupied and the property 102b is unoccupied, e.g., when the emergency event is flooding. The information can include different user interface elements for properties that are occupied compared to properties that are unoccupied.

Utilizing data about the one or more properties 102, e.g., by obtaining details gathered during sensor installation and details about the layout of devices in the property 102 (e.g., two thermostats is indicative of a larger home than one thermostat), or both, the emergency management system can establish groups of properties that may be at higher relative risk. For example, larger properties may have lower mortality risk during severe weather because there is more buffer between the core of the property 102 and the elements (e.g., in a smaller home you may not be able to hide in a room without windows, and thus are at higher risk of injury from flying glass). After the emergency 114, e.g., a hurricane or tornado, the data can indicate whether the property A 102a and the property B 102b may have been exposed to comparable wind speeds, rains, etc. If property A is 5,000 sq. ft. and Property B is 2,500 sq. ft., then Property B may have a higher risk score. In some examples, the emergency management system can use sensor data to determine the relative priorities.

The emergency management system can use the priorities to determine an amount with which to communication with a property monitoring system for the property. For instance, the emergency management system can communicate more frequently with a property monitoring system, or sensors for the property, that has a higher priority and less frequently with a property monitoring system that has a lower priority.

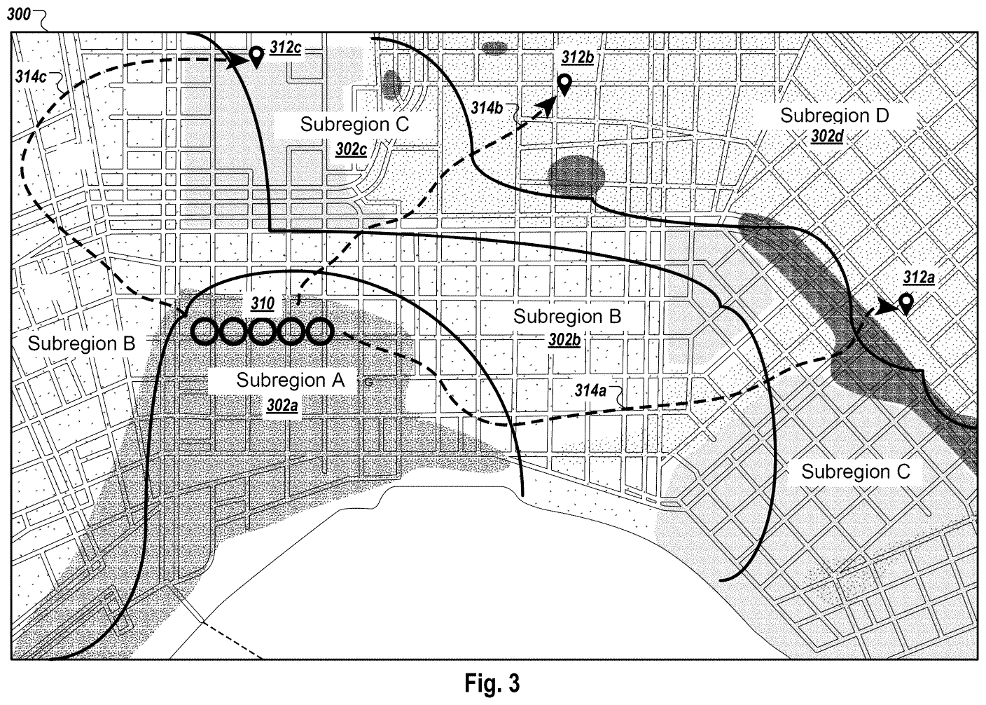

FIG. 3 is an example of a geographic region 300 that has one or more properties. The geographic region 300 can have a plurality of subregions 302 that include subregions A-D 302a-d. The subregions A-D 302a-d are representative, and it is understood that the geographic region 300 can include more or fewer subregions without departing from the scope of this disclosure. The geographic region 300 can be depicted in the map portion 206 of the GUI 200, shown in FIG. 2. Each of the subregions A-D 302a-d can be individually represented as the subregions 104 or 205, shown in FIGS. 1-2.

An emergency management system can determine the subregions 302 in the geographic region 300 using the risk scores for areas, e.g., properties, within the geographic region 300. The subregions can be depicted using one or more boundaries 304a-c, e.g., for presentation in the map portion 206 of the GUI 200.

For instance, the emergency management system can determine groups of areas that satisfy a similarity threshold. The similarity threshold can indicate that all of the areas within a subregion 302 have a risk score within a threshold distance of the risk scores for the other areas, e.g., properties.

When presented in the map portion 206, the geographic region 300 can include one or more user interface elements that represent the corresponding risk level. For instance, the first subregion A 302a can be represented by a red color indicating a high risk while a second subregion B 302b can be represented by a yellow color indicating a medium-high risk, a third subregion C 302c can be represented by a yellow-blue color indicating a medium-low risk, and a fourth subregion D 302d can be represented by a blue color indicating a low risk. Certain colors can be pre-designated as low risk colors and other colors can indicate a high-risk score.

When presented in the map portion 206 with user interface elements that represent a risk level, the geographic region 300 can indicate a priority for various emergency events. For instance, when the geographic region 300 includes a first emergency event in the first subregion A 302a and a second emergency event in the third subregion C 302c, the map portion 206 can indicate that the first emergency event should be addressed before the second emergency event.

The geographic region 300 can include information about a pathway 314a, e.g., the pathway 214. The pathway 314a can be directional in that the pathway 314a has a beginning, e.g., at a first location 310 in subregion A 302a, and an end, e.g., at a second location 312a in subregion D 302d.

In some implementations, the geographic region 300 can include multiple pathways. For instance, in FIG. 3, the first location 310 can be illustrated as a plurality of locations, e.g., at which one or more properties 102 are located. A second pathway 314b shows safe passage from another property in subregion A 302a to a third location 312b in subregion D 302d. In some examples, a third pathway 314c can show safe passage from another property in subregion A 302a to a fourth location 312c in subregion C 302c. These pathways 314a-c are generated, at least in part, by the emergency management system, utilizing sensor data 112. The emergency management system can transfer data for one or more of the pathways to the user device(s) 124 or other computer device(s).

The emergency management system can determine the pathways 314a-c, the risk scores, e.g., described with reference to FIG. 2, the priority ranking, or a combination of two or more of these, using any appropriate data. In some implementations, the emergency management system can use, e.g., as an external database source, a real estate system, such as directories, e.g., in order to provide additional parameters for the risk score. The real estate data can include square footage, photos, video, or a combination of these, of a property. The square footage, photos, or videos can be used to assess an individual's risk score based on the location of the occupant in the photo or video of the property. For example, during a tornado, video activity data could indicate that occupants of the property are hiding in a bathroom on the second floor of the property.

In some examples, the sensor data can indicate a floorplan of the property 102.

The emergency management system 116 can make inferences about a risk score and condition of properties 102 that do not have the sensor 120 installed by analyzing sensor data 112 from one or more adjacent properties.

The emergency management system 116 can use risk scores, priorities, or a combination of both, to analyze, request, or both, data. For instance, the emergency management system 116 can request more data from, analyze more data for, or both, a property with a risk score that indicates a higher risk rather than a lower risk.

In some implementations, the emergency management system 116 can determine multiple risk scores for a property or another type of area, e.g., a subway entrance. For example, the risk scores can include a property risk score, a demographic risk score, an activity risk score, a self-help risk score, or a combination of these. The property risk score can indicate a likelihood of a level of damage to the property 102. For example, the property risk can indicate a likelihood of flooding and be determined utilizing water sensors or video. The property risk score can indicate wind speed determined by analyzing video, a temperature estimated by utilizing temperature sensors or a thermostat, or a combination of both.

The demographic risk score, in some examples, can be obtained using a self-reported user profile. The demographic risk score can be determined using demographic data about one or more occupants of a given property.

An activity risk score can be determined using one or more machine learning algorithms (MLAs) that compare expected activity to actual activity after an emergency. The activity risk score can indicate data related to occupancy of the property 102 obtained from motion sensors, phone location, interaction with local devices, video data, and Wi-Fi sensing. The activity risk score can indicate whether external movement around the property 102 has been detected.

The self-help risk score can be a measure of the likelihood an occupant of the property 102 will be able to escape the property 102, seek shelter in a safe location, or a combination of both. In some implementations, indication of property damage, e.g., images of a caved in roof create an inference in the emergency management system 116 that an occupant is trapped inside and unable to leave.

In some implementations, a neighborhood risk score, or geographic region risk score, can indicate data about a neighborhood or a geographic region. These risk scores can indicate a number of properties without power; a number of areas with outdoor temperatures at or below 20° F.; indoor temperatures inside the one or more properties currently at 50° F. and dropping at a rate of 5° F. per hour; whether streets providing ingress or egress to an area are blocked, e.g., by downed trees, power lines, or both; or a combination of two or more of these.

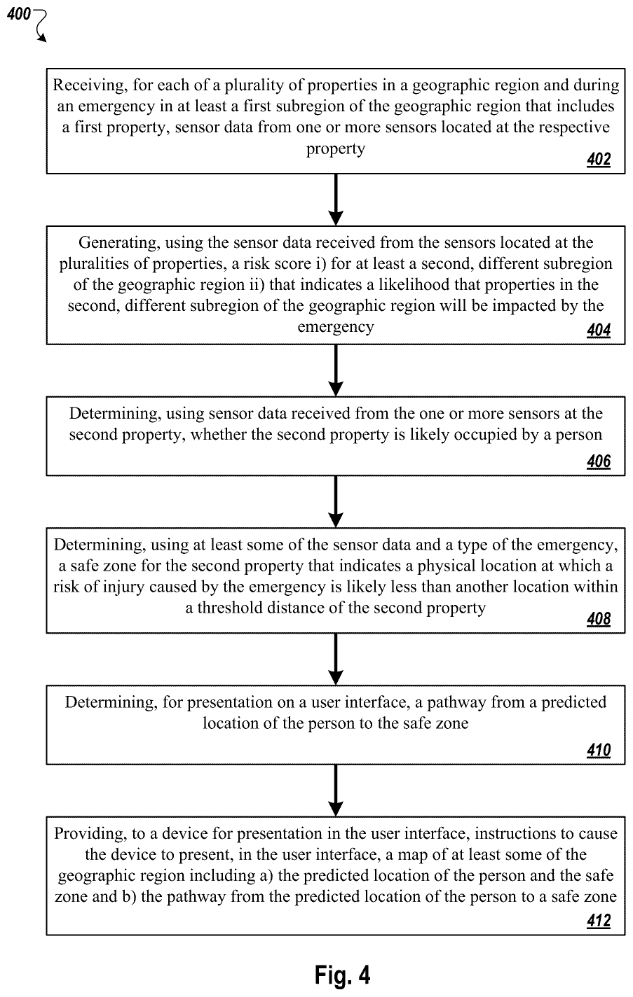

FIG. 4 depicts an example flow chart indicating a process 400 for causing presentation of a user interface. The process 400 can begin at operation 402. At operation 402, the process 400 proceeds by receiving, for each of a plurality of properties in a geographic region, and during an emergency in at least a first subregion of the geographic region that includes a first property, sensor data from one or more sensors located at the respective property. The plurality of properties include the first property in the first subregion of the geographic region and a second property in a second subregion of the geographic region. The first subregion of the geographic region is different from the second subregion of the geographic region.

At operation 404, the process 400 continues by generating, using the sensor data received from the sensors located at the pluralities of properties, a risk score. The risk score is generated for at least a second subregion of the geographic region that is different from the first subregion of the geographic region. The risk score indicates a likelihood that properties in the second, different subregion of the geographic region will be impacted by the emergency.

Sensor data 112 can be consolidated and analyzed to determine the risk score for an area. The area can be a property, a subregion, or the geographic region. A subregion can include a block, a neighborhood, or a combination of both.

In response to determining that the risk score does not satisfy the score threshold, the process 500 can determine to stop, determine to restart with operation 402, or perform another appropriate operation.

The process continues with operation 406. In response to determining that the risk score satisfies the score threshold, the process 400 proceeds by determining, using sensor data received from the one or more sensors at the second property, whether the second property is likely occupied by a person.

In some implementations, the process 400 can determine that the second property in the geographic region is unoccupied. In response to determining that the second property in the geographic region is unoccupied, the process 400 proceeds by determining to skip communicating with a system for the second property, e.g., a property monitoring system or a sensor for the second property.

The process 400 continues to operation 408, where in response to determining that the second property is likely occupied by a person: the process 400 proceeds by determining, using at least some of the sensor data and a type of the emergency, a safe zone for the second property that indicates a physical location at which a risk of injury caused by the emergency is likely less than another location within a threshold distance of the second property.

At operation 410, the process 400 proceeds by determining, for presentation on a user interface, a pathway from a predicted location of the person to the safe zone. An emergency management system, e.g., performing the process 400, can determine the pathway using data identifies locations or resources (e.g., a hospital, evacuation sites, stores) in a subregion outside of the subregion in which the emergency occurs.

In some implementations, the pathway to the safe zone could be sent as a message to a user device via an application. In some examples, the message can cause presentation, on a map, of a location in a predetermined color, e.g., green, in order to communicate a location of the safe zone.

In some implementations, a sensor, such as the sensor 120, may only capture a snapshot of a certain area within a region or zone. The captured snapshot can be provided to the MLA in control unit 110, the emergency management system 116, or the emergency detection engine 118. The result(s) of the MLA can be compared to open-source mapping data, e.g., timestamped images occurring prior to the emergency, which can predict whether a certain pathway to the safe zone is likely safe and unobstructed, or blocked. The MLA can be integrated into one or more of the control units 110, the emergency management system 116, or the emergency detection engine 118. For example, if a partial image of a downed tree is shown blocking a portion of a road, the MLA can be used to predict whether the entirety of the road is blocked, utilizing information from images taken prior to the emergency 114, such a height and width of the currently downed tree.

At operation 412, the process 400 proceeds by providing, to a device for presentation in the user interface, instructions to cause the device to present, in the user interface, a map of at least some of the geographic region. The map includes a) the predicted location of the person and the safe zone and b) the pathway from the predicted location of the person to a safe zone. The device can be any appropriate type of device, such as a device of a property occupant, a first responder, or another appropriate person.

In some implementations, after providing the instructions, the process 400 can determine whether an updated predicted location, e.g., of the person, satisfies a distance threshold for the second property. In response to determining that the updated predicted location does not satisfy the distance threshold for the second property, e.g., and that the property is likely unoccupied, the process 400 proceeds by changing a frequency of analysis of sensor data for the second property. For instance, the emergency management system can reduce a frequency of analysis of the sensor data, saving computational resources. This can occur when the emergency management system needs those resources to analyze other data in areas likely still occupied by people, for ongoing risks to people, or a combination of both, e.g., when such analysis might otherwise not be possible. In some implementations, the process 400 continues by determining whether the updated predicted location satisfies the distance threshold for the second property includes determining whether the second property is unoccupied. Changing the frequency of analysis of sensor data for the second property is responsive to determining that the second property is unoccupied.

In some implementations, advantageously, by aggregating and analyzing data, properties in potential distress can be identified and response by emergency responders can be prioritized based on the properties having a highest risk score. A system can using current risk levels, rates of change, or both, to predict critical response periods, the movement of the emergency, or both. For example, a property within a pathway of a forest fire can rapidly increase temperature and may require evacuation. Analyzing data that indicates that properties in the east of the city are rising in temperature faster than those in the west, can be used to determine the trajectory of the fire. The data could be used to notify occupants of the need to evacuate the property by a certain time, help authorities with the timing and prioritization of resources, or a combination of both.

In some examples, an individual property risk score is determined. Sensor data 112 may indicate that multiple properties 102 are currently occupied and some are unoccupied that show no activity within 24 hours of initiation of the emergency. Occupancy can be determined using the location of the user device, whether data is received from motion or video sensors, and/or information obtained from with sensors within the property (e.g., whether a thermostat has been changed). In some examples, one of the multiple properties 102 is occupied by a person with heart condition, information that could be obtained during device setup, or received from the occupant's device account. Video images, i.e., sensor data 112, from a nearby outdoor camera indicates that the property occupied by the person with the heart condition, show a fallen tree. Absent additional information, an emergency event, the property, or both, for the person with the heart condition would receive a higher individual property risk score than the unoccupied properties or occupied properties with people without a heart condition, absent other extenuating circumstances. In some examples, the occupied properties will receive a higher individual property risk score than the unoccupied properties.

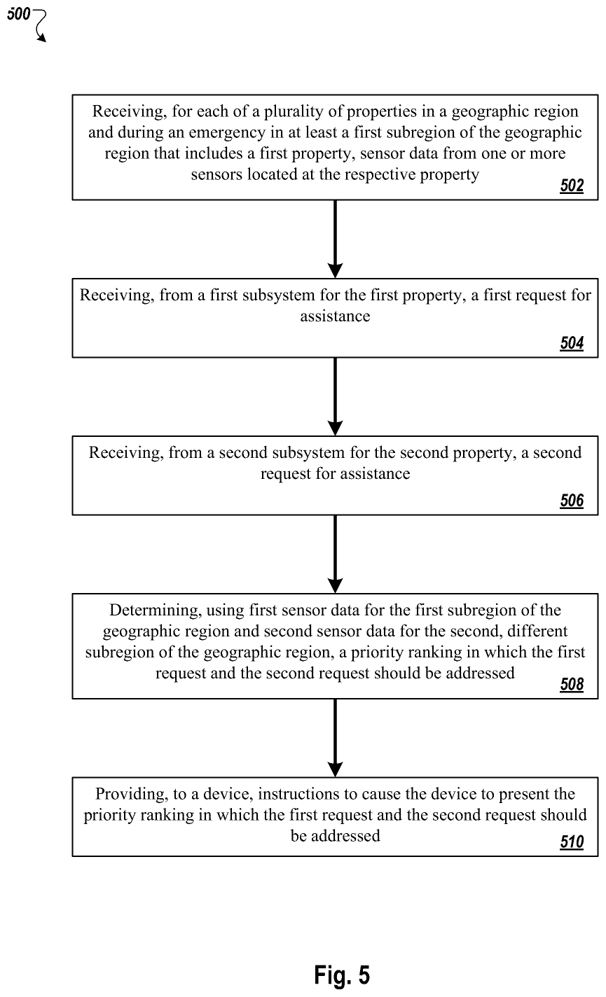

FIG. 5 depicts an example flow chart indicating a process 500 for causing presentation of a priority ranking. The process 500 can begin at operation 502 by receiving, for each of a plurality of properties in a geographic region and during an emergency in at least a first subregion of the geographic region that includes a first property. Sensor data can be obtained from one or more sensors located at the respective property, the plurality of properties including the first property in the first subregion of the geographic region and a second property in a second, different subregion of the geographic region.

At operation 504, the process 500 can proceed by receiving, from a first subsystem for the first property, a first request for assistance. The first request can indicate a first type of assistance requested, such as assistance with a fall.

At operation 506, the process 500 continues by receiving, from a second subsystem for the second property, a second request for assistance. The second request can indicate a second type of assistance requested, such as assistance with flooding in a basement.

At operation 508, the process 500 continues by determining, using first sensor data for the first subregion of the geographic region and second sensor data for the second, different subregion of the geographic region, a priority ranking in which the first request and the second request should be addressed. In some examples, the process 500 can use the first assistance type and the second assistance type to determine the priority ranking. The process 500 can use the assistance types in addition to or instead of using the sensor data. In some examples, the process 500 can determine predicted assistance types using the sensor data.

At operation 510, the process 500 provides, to a device, instructions to cause the device to present the priority ranking in which the first request and the second request should be addressed. The device can be any appropriate type of device, such as a device of a first responder, a device at an emergency communications center, or another appropriate type of device.

In some implementations of the process 500, a frequency is determined with which to analyze sensor data for the respective subregion of the geographic region. The frequency can be determined for one or more subregions of the geographic region and using the priority ranking. The process 500 may analyze, for the one or more subregions of the geographic region and using the frequency, sensor data received from one or more properties in the respective region.

In some implementations, the process 500 can determine, for one or more subregions of the geographic region and using the priority ranking, a frequency with which to request sensor data for the respective subregion of the geographic region. The frequency can be communicated with one or more properties in a subregion of the one or more portions using.

In some implementations, the process 500 can cause presentation of data on multiple different devices. For instance, the process 500 can cause presentation of data on the device in addition to one or more devices for the first request, the second request, or both. For instance, the process 500 can determine, using data for the first request and the priority ranking, to provide, to another device for the first request, second instructions for addressing the first request. The process 500 can provide, to the other device, the second instructions for addressing the first request. When the process 500 provides the instructions to the device, e.g., the first responder device, the process 500 can provide the instructions to cause the device to present the priority ranking that includes data indicating that instructions for the first request were provided to the other device.

The order of steps in the processes 400 and 500 described above is illustrative only, and the process 400 and 500 can be performed in different orders, can include more or fewer operations, or a combination of both. For instance, the process 500 can be performed, at least in part, with one or more operations from the process 400.

For situations in which the systems discussed here collect personal information about people, or may make use of personal information, the people may be provided with an opportunity to control whether programs or features collect personal information (e.g., a person's preferences, information about a person's property, or a person's current location), or to control whether and/or how to receive content from the emergency management system. In addition, certain data may be anonymized in one or more ways before it is stored or used, so that personally identifiable information is removed. For example, a user's identity may be anonymized so that no personally identifiable information can be determined for the person, or a person's geographic location may be generalized where location information is obtained (such as to a city, ZIP code, or state level), so that a particular location of a user cannot be determined. Thus, the person may have control over how information is collected about him or her and used.

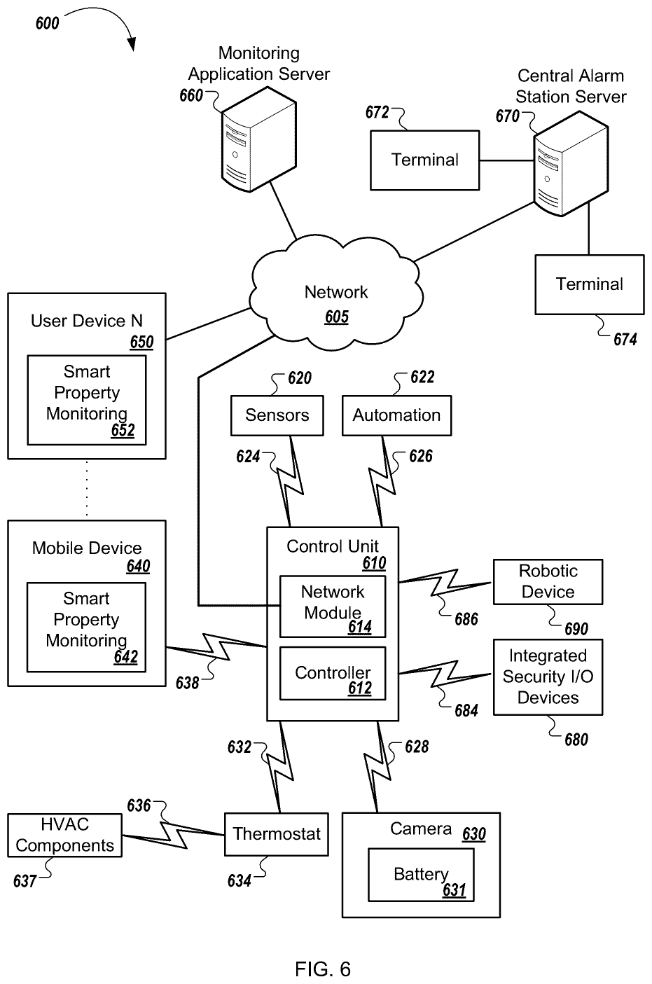

FIG. 6 is a diagram illustrating an example of a property monitoring system 600. The property monitoring system 600 includes a network 605, a control unit 610, one or more user devices 640 and 650, a monitoring application server 660, and a central alarm station server 670. In some examples, the network 605 facilitates communications between the control unit 610, the one or more user devices 640 and 650, the monitoring application server 660, and the central alarm station server 670.

The network 605 is configured to enable exchange of electronic communications between devices connected to the network 605. For example, the network 605 may be configured to enable exchange of electronic communications between the control unit 610, the one or more user devices 640 and 650, the monitoring application server 660, and the central alarm station server 670. The network 605 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 605 may include multiple networks or subnetworks, each of which may include, for example, a wired or wireless data pathway. The network 605 may include a circuit-switched network, a packet-switched data network, or any other network able to carry electronic communications (e.g., data or voice communications). For example, the network 605 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 605 may include one or more networks that include wireless data channels and wireless voice channels. The network 605 may be a wireless network, a broadband network, or a combination of networks including a wireless network and a broadband network.

The control unit 610 includes a controller 612 and a network module 614. The controller 612 is configured to control a control unit monitoring system (e.g., a control unit system) that includes the control unit 610. In some examples, the controller 612 may include a processor or other control circuitry configured to execute instructions of a program that controls operation of a control unit system. In these examples, the controller 612 may be configured to receive input from sensors, flow meters, or other devices included in the control unit system and control operations of devices included in the household (e.g., speakers, lights, doors, etc.). For example, the controller 612 may be configured to control operation of the network module 614 included in the control unit 610.

The network module 614 is a communication device configured to exchange communications over the network 605. The network module 614 may be a wireless communication module configured to exchange wireless communications over the network 605. For example, the network module 614 may be a wireless communication device configured to exchange communications over a wireless data channel and a wireless voice channel. In this example, the network module 614 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 614 also may be a wired communication module configured to exchange communications over the network 605 using a wired connection. For instance, the network module 614 may be a modem, a network interface card, or another type of network interface device. The network module 614 may be an Ethernet network card configured to enable the control unit 610 to communicate over a local area network and/or the Internet. The network module 614 also may be a voice band modem configured to enable the alarm panel to communicate over the telephone lines of Plain Old Telephone Systems (POTS).

The control unit system that includes the control unit 610 includes one or more sensors. For example, the property monitoring system 600 may include multiple sensors 620. The sensors 620 may include a lock sensor, a contact sensor, a motion sensor, or any other type of sensor included in a control unit system. The sensors 620 also may include an environmental sensor, such as a temperature sensor, a water sensor, a rain sensor, a wind sensor, a light sensor, a smoke detector, a carbon monoxide detector, an air quality sensor, etc. The sensors 620 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the property. The health monitoring sensor can collect various health data, including pulse, heart rate, respiration rate, sugar or glucose level, bodily temperature, or motion data. The sensors 620 can include a radio-frequency identification (RFID) sensor that identifies a particular article that includes a pre-assigned RFID tag.

The control unit 610 communicates with the module 622 and a camera 630 to perform monitoring. The module 622 is connected to one or more devices that enable property automation, e.g., home or business automation. For instance, the module 622 may be connected to one or more lighting systems and may be configured to control operation of the one or more lighting systems. Also, the module 622 may be connected to one or more electronic locks at the property and may be configured to control operation of the one or more electronic locks (e.g., control Z-Wave locks using wireless communications in the Z-Wave protocol). Further, the module 622 may be connected to one or more appliances at the property and may be configured to control operation of the one or more appliances. The module 622 may include multiple modules that are each specific to the type of device being controlled in an automated manner. The module 622 may control the one or more devices based on commands received from the control unit 610. For instance, the module 622 may cause a lighting system to illuminate an area to provide a better image of the area when captured by a camera 630. The camera 630 can include one or more batteries 631 that require charging.

The robotic device 690, which can be a drone. The drone 690 can be used to survey the electronic system 600. In particular, the drone 690 can capture images of each item found in the electronic system 600 and provide images to the control unit 610 for further processing. Alternatively, the drone 690 can process the images to determine an identification of the items found in the electronic system 600.

The camera 630 may be a video/photographic camera or other type of optical sensing device configured to capture images. For instance, the camera 630 may be configured to capture images of an area within a property monitored by the control unit 610. The camera 630 may be configured to capture single, static images of the area or video images of the area in which multiple images of the area are captured at a relatively high frequency (e.g., thirty images per second) or both. The camera 630 may be controlled based on commands received from the control unit 610.

The camera 630 may be triggered by several different types of techniques. For instance, a Passive Infra-Red (PIR) motion sensor may be built into the camera 630 and used to trigger the camera 630 to capture one or more images when motion is detected. The camera 630 also may include a microwave motion sensor built into the camera and used to trigger the camera 630 to capture one or more images when motion is detected. The camera 630 may have a “normally open” or “normally closed” digital input that can trigger capture of one or more images when external sensors (e.g., the sensors 620, PIR, door/window, etc.) detect motion or other events. In some implementations, the camera 630 receives a command to capture an image when external devices detect motion or another potential alarm event. The camera 630 may receive the command from the controller 612 or directly from one of the sensors 620.

In some examples, the camera 630 triggers integrated or external illuminators (e.g., Infra-Red, Z-wave controlled “white” lights, lights controlled by the module 622, etc.) to improve image quality when the scene is dark. An integrated or separate light sensor may be used to determine if illumination is desired and may result in increased image quality.

The camera 630 may be programmed with any combination of time/day schedules, system “arming state”, or other variables to determine whether images should be captured or not when triggers occur. The camera 630 may enter a low-power mode when not capturing images. In this case, the camera 630 may wake periodically to check for inbound messages from the controller 612. The camera 630 may be powered by internal, replaceable batteries, e.g., if located remotely from the control unit 610. The camera 630 may employ a small solar cell to recharge the battery when light is available. The camera 630 may be powered by the controller's 612 power supply if the camera 630 is co-located with the controller 612.

In some implementations, the camera 630 communicates directly with the monitoring application server 660 over the Internet. In these implementations, image data captured by the camera 630 does not pass through the control unit 610 and the camera 630 receives commands related to operation from the monitoring application server 660.

The property monitoring system 600 also includes thermostat 634 to perform dynamic environmental control at the property. The thermostat 634 is configured to monitor temperature and/or energy consumption of an HVAC system associated with the thermostat 634, and is further configured to provide control of environmental (e.g., temperature) settings. In some implementations, the thermostat 634 can additionally or alternatively receive data relating to activity at a property and/or environmental data at a property, e.g., at various locations indoors and outdoors at the property. The thermostat 634 can directly measure energy consumption of the HVAC system associated with the thermostat, or can estimate energy consumption of the HVAC system associated with the thermostat 634, for example, based on detected usage of one or more components of the HVAC system associated with the thermostat 634. The thermostat 634 can communicate temperature and/or energy monitoring information to or from the control unit 610 and can control the environmental (e.g., temperature) settings based on commands received from the control unit 610.

In some implementations, the thermostat 634 is a dynamically programmable thermostat and can be integrated with the control unit 610. For example, the thermostat 634, which can be a dynamically programmable thermostat, can include the control unit 610, e.g., as an internal component to the thermostat 634. In addition, the control unit 610 can be a gateway device that communicates with the thermostat 634. In some implementations, the thermostat 634 is controlled via one or more module 622.

A module 637 is connected to one or more components of an HVAC system associated with a property, and is configured to control operation of the one or more components of the HVAC system. In some implementations, the module 637 is also configured to monitor energy consumption of the HVAC system components, for example, by directly measuring the energy consumption of the HVAC system components or by estimating the energy usage of the one or more HVAC system components based on detecting usage of components of the HVAC system. The module 637 can communicate energy monitoring information and the state of the HVAC system components to the thermostat 634 and can control the one or more components of the HVAC system based on commands received from the thermostat 634.

In some examples, the property monitoring system 600 further includes one or more robotic devices 690. The robotic devices 690 may be any type of robots that are capable of moving and taking actions that assist in security monitoring. For example, the robotic devices 690 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and also roll along the ground, walls, or ceiling) and land vehicle type devices (e.g., automated cars that drive around a property). In some cases, the robotic devices 690 may be robotic devices 690 that are intended for other purposes and merely associated with the property monitoring system 600 for use in appropriate circumstances. For instance, a robotic vacuum cleaner device may be associated with the property monitoring system 600 as one of the robotic devices 690 and may be controlled to take action responsive to monitoring system events.

In some examples, the robotic devices 690 automatically navigate within a property. In these examples, the robotic devices 690 include sensors and control processors that guide movement of the robotic devices 690 within the property. For instance, the robotic devices 690 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 690 may include control processors that process output from the various sensors and control the robotic devices 690 to move along a path that reaches the desired destination and avoids obstacles. In this regard, the control processors detect walls or other obstacles in the property and guide movement of the robotic devices 690 in a manner that avoids the walls and other obstacles.

In addition, the robotic devices 690 may store data that describes attributes of the property. For instance, the robotic devices 690 may store a floorplan and/or a three-dimensional model of the property that enables the robotic devices 690 to navigate the property. During initial configuration, the robotic devices 690 may receive the data describing attributes of the property, determine a frame of reference to the data (e.g., a property or reference location in the property), and navigate the property based on the frame of reference and the data describing attributes of the property. Further, initial configuration of the robotic devices 690 also may include learning of one or more navigation patterns in which a user provides input to control the robotic devices 690 to perform a specific navigation action (e.g., fly to an upstairs bedroom and spin around while capturing video and then return to a property charging base). In this regard, the robotic devices 690 may learn and store the navigation patterns such that the robotic devices 690 may automatically repeat the specific navigation actions upon a later request.

In some examples, the robotic devices 690 may include data capture and recording devices. In these examples, the robotic devices 690 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the property and users in the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 690 to take and store a biometric sample that can be used to identify the person (e.g., a biometric sample with DNA that can be used for DNA testing).

In some implementations, the robotic devices 690 may include output devices. In these implementations, the robotic devices 690 may include one or more displays, one or more speakers, and/or any type of output devices that allow the robotic devices 690 to communicate information to a nearby user.

The robotic devices 690 also may include a communication module that enables the robotic devices 690 to communicate with the control unit 610, each other, and/or other devices. The communication module may be a wireless communication module that allows the robotic devices 690 to communicate wirelessly. For instance, the communication module may be a Wi-Fi module that enables the robotic devices 690 to communicate over a local wireless network at the property. The communication module further may be a 900 MHz wireless communication module that enables the robotic devices 690 to communicate directly with the control unit 610. Other types of short-range wireless communication protocols, such as Bluetooth, Bluetooth LE, Z-wave, Zigbee, etc., may be used to allow the robotic devices 690 to communicate with other devices in the property. In some implementations, the robotic devices 690 may communicate with each other or with other devices of the property monitoring system 600 through the network 605.

The robotic devices 690 further may include processor and storage capabilities. The robotic devices 690 may include any suitable processing devices that enable the robotic devices 690 to operate applications and perform the actions described throughout this disclosure. In addition, the robotic devices 690 may include solid-state electronic storage that enables the robotic devices 690 to store applications, configuration data, collected sensor data, and/or any other type of information available to the robotic devices 690.

The robotic devices 690 are associated with one or more charging stations. The charging stations may be located at predefined home base or reference locations in the property. The robotic devices 690 may be configured to navigate to the charging stations after completion of tasks needed to be performed for the property monitoring system 600. For instance, after completion of a monitoring operation or upon instruction by the control unit 610, the robotic devices 690 may be configured to automatically fly to and land on one of the charging stations. In this regard, the robotic devices 690 may automatically maintain a fully charged battery in a state in which the robotic devices 690 are ready for use by the property monitoring system 600.

The charging stations may be contact based charging stations and/or wireless charging stations. For contact-based charging stations, the robotic devices 690 may have readily accessible points of contact that the robotic devices 690 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 690 may charge through a wireless exchange of power. In these cases, the robotic devices 690 need only locate themselves closely enough to the wireless charging stations for the wireless exchange of power to occur. In this regard, the positioning needed to land at a predefined home base or reference location in the property may be less precise than with a contact-based charging station. Based on the robotic devices 690 landing at a wireless charging station, the wireless charging station outputs a wireless signal that the robotic devices 690 receive and convert to a power signal that charges a battery maintained on the robotic devices 690.

In some implementations, each of the robotic devices 690 has a corresponding and assigned charging station such that the number of robotic devices 690 equals the number of charging stations. In these implementations, the robotic devices 690 always navigate to the specific charging station assigned to that robotic device. For instance, a first robotic device may always use a first charging station and a second robotic device may always use a second charging station.

In some examples, the robotic devices 690 may share charging stations. For instance, the robotic devices 690 may use one or more community charging stations that are capable of charging multiple robotic devices 690. The community charging station may be configured to charge multiple robotic devices 690 in parallel. The community charging station may be configured to charge multiple robotic devices 690 in serial such that the multiple robotic devices 690 take turns charging and, when fully charged, return to a predefined home base or reference location in the property that is not associated with a charger. The number of community charging stations may be less than the number of robotic devices 690.

Also, the charging stations may not be assigned to specific robotic devices 690 and may be capable of charging any of the robotic devices 690. In this regard, the robotic devices 690 may use any suitable, unoccupied charging station when not in use. For instance, when one of the robotic devices 690 has completed an operation or is in need of battery charge, the control unit 610 references a stored table of the occupancy status of each charging station and instructs the robotic device to navigate to the nearest charging station that is unoccupied.

The property monitoring system 600 further includes one or more integrated security devices 680. The one or more integrated security devices may include any type of device used to provide alerts based on received sensor data. For instance, the one or more control units 610 may provide one or more alerts to the one or more integrated security input/output devices 680. Additionally, the one or more control units 610 may receive sensor data from the sensors 620 and determine whether to provide an alert to the one or more integrated security input/output devices 680.

The sensors 620, the module 622, the camera 630, the thermostat 634, and the integrated security devices 680 may communicate with the controller 612 over communication links 624, 626, 628, 632, 638, 684, and 686. The communication links 624, 626, 628, 632, 638, 684, and 686 may be a wired or wireless data pathway configured to transmit signals from the sensors 620, the module 622, the camera 630, the thermostat 634, the drone 690, and the integrated security devices 680 to the controller 612. The sensors 620, the module 622, the camera 630, the thermostat 634, the drone 690, and the integrated security devices 680 may continuously transmit sensed values to the controller 612, periodically transmit sensed values to the controller 612, or transmit sensed values to the controller 612 in response to a change in a sensed value. In some implementations, the drone 690 can communicate with the monitoring application server 660 over network 605. The drone 690 can connect and communicate with the monitoring application server 660 using a Wi-Fi or a cellular connection.

The communication links 624, 626, 628, 632, 638, 684, and 686 may include a local network. The sensors 620, the module 622, the camera 630, the thermostat 634, the drone 690 and the integrated security devices 680, and the controller 612 may exchange data and commands over the local network. The local network may include 802.11 “Wi-Fi” wireless Ethernet (e.g., using low-power Wi-Fi chipsets), Z-Wave, Zigbee, Bluetooth, “HomePlug” or other “Powerline” networks that operate over AC wiring, and a Category 5 (CAT5) or Category 6 (CAT6) wired Ethernet network. The local network may be a mesh network constructed based on the devices connected to the mesh network.

The monitoring application server 660 is an electronic device configured to provide monitoring services by exchanging electronic communications with the control unit 610, the one or more user devices 640 and 650, and the central alarm station server 670 over the network 605. For example, the monitoring application server 660 may be configured to monitor events (e.g., alarm events) generated by the control unit 610. In this example, the monitoring application server 660 may exchange electronic communications with the network module 614 included in the control unit 610 to receive information regarding events (e.g., alerts) detected by the control unit 610. The monitoring application server 660 also may receive information regarding events (e.g., alerts) from the one or more user devices 640 and 650.

In some examples, the monitoring application server 660 may route alert data received from the network module 614 or the one or more user devices 640 and 650 to the central alarm station server 670. For example, the monitoring application server 660 may transmit the alert data to the central alarm station server 670 over the network 605.

The monitoring application server 660 may store sensor and image data received from the property monitoring system 600 and perform analysis of sensor and image data received from the monitoring system 600. Based on the analysis, the monitoring application server 660 may communicate with and control aspects of the control unit 610 or the one or more user devices 640 and 650.

The monitoring application server 660 may provide various monitoring services to the property monitoring system 600. For example, the monitoring application server 660 may analyze the sensor, image, and other data to determine an activity pattern of a resident of the property monitored by the property monitoring system 600. In some implementations, the monitoring application server 660 may analyze the data for alarm conditions or may determine and perform actions at the property by issuing commands to one or more components of the property monitoring system 600, possibly through the control unit 610.

The central alarm station server 670 is an electronic device configured to provide alarm monitoring service by exchanging communications with the control unit 610, the one or more mobile devices 640 and 650, and the monitoring application server 660 over the network 605. For example, the central alarm station server 670 may be configured to monitor alerting events generated by the control unit 610. In this example, the central alarm station server 670 may exchange communications with the network module 614 included in the control unit 610 to receive information regarding alerting events detected by the control unit 610. The central alarm station server 670 also may receive information regarding alerting events from the one or more mobile devices 640 and 650 and/or the monitoring application server 660.

The central alarm station server 670 is connected to multiple terminals 672 and 674. The terminals 672 and 674 may be used by operators to process alerting events. For example, the central alarm station server 670 may route alerting data to the terminals 672 and 674 to enable an operator to process the alerting data. The terminals 672 and 674 may include general-purpose computers (e.g., desktop personal computers, workstations, or laptop computers) that are configured to receive alerting data from a server in the central alarm station server 670 and render a display of information based on the alerting data. For instance, the controller 612 may control the network module 614 to transmit, to the central alarm station server 670, alerting data indicating that a sensor 620 detected motion from a motion sensor via the sensors 620. The central alarm station server 670 may receive the alerting data and route the alerting data to the terminal 672 for processing by an operator associated with the terminal 672. The terminal 672 may render a display to the operator that includes information associated with the alerting event (e.g., the lock sensor data, the motion sensor data, the contact sensor data, etc.) and the operator may handle the alerting event based on the displayed information.

In some implementations, the terminals 672 and 674 may be mobile devices or devices designed for a specific function. Although FIG. 6 illustrates two terminals for brevity, actual implementations may include more (and, perhaps, many more) terminals.

The one or more user devices 640 and 650 are devices that host and display user interfaces. For instance, the user device 640 is a mobile device that hosts or runs one or more native applications (e.g., the smart property application 642). The user device 640 may be a cellular phone or a non-cellular locally networked device with a display. The user device 640 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 640 may perform functions unrelated to the monitoring system, such as placing personal telephone calls, playing music, playing video, displaying pictures, browsing the Internet, maintaining an electronic calendar, etc.

The user device 640 includes a smart property application 642. The smart property application 642 refers to a software/firmware program running on the corresponding mobile device that enables the user interface and features described throughout. The user device 640 may load or install the smart property application 642 based on data received over a network or data received from local media. The smart property application 642 runs on mobile devices platforms, such as iPhone, iPod touch, Blackberry, Google Android, Windows Mobile, etc. The smart property application 642 enables the user device 640 to receive and process image and sensor data from the monitoring system.

The user device 650 may be a general-purpose computer (e.g., a desktop personal computer, a workstation, or a laptop computer) that is configured to communicate with the monitoring application server 660 and/or the control unit 610 over the network 605. The user device 650 may be configured to display a smart property user interface 652 that is generated by the user device 650 or generated by the monitoring application server 660. For example, the user device 650 may be configured to display a user interface (e.g., a web page) provided by the monitoring application server 660 that enables a user to perceive images captured by the camera 630 and/or reports related to the monitoring system. Although FIG. 6 illustrates two user devices for brevity, actual implementations may include more (and, perhaps, many more) or fewer user devices.

In some implementations, the one or more user devices 640 and 650 communicate with and receive monitoring system data from the control unit 610 using the communication link 638. For instance, the one or more user devices 640 and 650 may communicate with the control unit 610 using various local wireless protocols such as Wi-Fi, Bluetooth, Z-wave, Zigbee, HomePlug (Ethernet over power line), or wired protocols such as Ethernet and USB, to connect the one or more user devices 640 and 650 to local security and automation equipment. The one or more user devices 640 and 650 may connect locally to the monitoring system and its sensors and other devices. The local connection may improve the speed of status and control communications because communicating through the network 605 with a remote server (e.g., the monitoring application server 660) may be significantly slower.

Although the one or more user devices 640 and 650 are shown as communicating with the control unit 610, the one or more user devices 640 and 650 may communicate directly with the sensors and other devices controlled by the control unit 610. In some implementations, the one or more user devices 640 and 650 replace the control unit 610 and perform the functions of the control unit 610 for local monitoring and long range/offsite communication.

In other implementations, the one or more user devices 640 and 650 receive monitoring system data captured by the control unit 610 through the network 605. The one or more user devices 640, 650 may receive the data from the control unit 610 through the network 605 or the monitoring application server 660 may relay data received from the control unit 610 to the one or more user devices 640 and 650 through the network 605. In this regard, the monitoring application server 660 may facilitate communication between the one or more user devices 640 and 650 and the monitoring system.

In some implementations, the one or more user devices 640 and 650 may be configured to switch whether the one or more user devices 640 and 650 communicate with the control unit 610 directly (e.g., through communication link 638) or through the monitoring application server 660 (e.g., through network 605) based on a location of the one or more user devices 640 and 650. For instance, when the one or more user devices 640 and 650 are located close to the control unit 610 and in range to communicate directly with the control unit 610, the one or more user devices 640 and 650 use direct communication. When the one or more user devices 640 and 650 are located far from the control unit 610 and not in range to communicate directly with the control unit 610, the one or more user devices 640 and 650 use communication through the monitoring application server 660.

Although the one or more user devices 640 and 650 are shown as being connected to the network 605, in some implementations, the one or more user devices 640 and 650 are not connected to the network 605. In these implementations, the one or more user devices 640 and 650 communicate directly with one or more of the monitoring system components and no network (e.g., Internet) connection or reliance on remote servers is needed.

In some implementations, the one or more user devices 640 and 650 are used in conjunction with only local sensors and/or local devices in a house. In these implementations, the property monitoring system 600 includes the one or more user devices 640 and 650, the sensors 620, the module 622, the camera 630, and the robotic devices, e.g., that can include the drone 690. The one or more user devices 640 and 650 receive data directly from the sensors 620, the module 622, the camera 630, and the robotic devices and send data directly to the sensors 620, the module 622, the camera 630, and the robotic devices. The one or more user devices 640, 650 provide the appropriate interfaces/processing to provide visual surveillance and reporting.

In other implementations, the property monitoring system 600 further includes network 605 and the sensors 620, the module 622, the camera 630, the thermostat 634, and the robotic devices are configured to communicate sensor and image data to the one or more user devices 640 and 650 over network 605 (e.g., the Internet, cellular network, etc.). In some implementations, the sensors 620, the module 622, the camera 630, the thermostat 634, and the robotic devices are intelligent enough to change the communication pathway from a direct local pathway when the one or more user devices 640 and 650 are in close physical proximity to the sensors 620, the module 622, the camera 630, the thermostat 634, and the robotic devices to a pathway over network 605 when the one or more user devices 640 and 650 are farther from the sensors 620, the module 622, the camera 630, the thermostat 634, and the robotic devices. In some examples, the system leverages GPS information from the one or more user devices 640 and 650 to determine whether the one or more user devices 640 and 650 are close enough to the sensors 620, the module 622, the camera 630, the thermostat 634, and the robotic devices to use the direct local pathway or whether the one or more user devices 640 and 650 are far enough from the sensors 620, the module 622, the camera 630, the thermostat 634, and the robotic devices that the pathway over network 605 is required. In other examples, the system leverages status communications (e.g., pinging) between the one or more user devices 640 and 650 and the sensors 620, the module 622, the camera 630, the thermostat 634, and the robotic devices to determine whether communication using the direct local pathway is possible. If communication using the direct local pathway is possible, the one or more user devices 640 and 650 communicate with the sensors 620, the module 622, the camera 630, the thermostat 634, and the robotic devices using the direct local pathway. If communication using the direct local pathway is not possible, the one or more user devices 640 and 650 communicate with the sensors 620, the module 622, the camera 630, the thermostat 634, and the robotic devices using the pathway over network 605.

In some implementations, the property monitoring system 600 provides end users with access to images captured by the camera 630 to aid in decision-making. The property monitoring system 600 may transmit the images captured by the camera 630 over a wireless WAN network to the user devices 640 and 650. Because transmission over a wireless WAN network may be relatively expensive, the property monitoring system 600 can use several techniques to reduce costs while providing access to significant levels of useful visual information (e.g., compressing data, down-sampling data, sending data only over inexpensive LAN connections, or other techniques).

In some implementations, a state of the property monitoring system 600 and other events sensed by the property monitoring system 600 may be used to enable/disable video/image recording devices (e.g., the camera 630). In these implementations, the camera 630 may be set to capture images on a periodic basis when the alarm system is armed in an “away” state, but set not to capture images when the alarm system is armed in a “stay” state or disarmed. In addition, the camera 630 may be triggered to begin capturing images when the alarm system detects an event, such as an alarm event, a door-opening event for a door that leads to an area within a field of view of the camera 630, or motion in the area within the field of view of the camera 630. In other implementations, the camera 630 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random-access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A computer-implemented method comprising:
receiving, for each of a plurality of properties in a geographic region and during an emergency in at least a first subregion of the geographic region that includes a first property, sensor data from one or more sensors located at the respective property, the plurality of properties including the first property in the first subregion of the geographic region and a second property in a second, different subregion of the geographic region;
generating, using the sensor data received from the sensors located at the pluralities of properties, a risk score i) for at least a second, different subregion of the geographic region ii) that indicates a likelihood that properties in the second, different subregion of the geographic region will be impacted by the emergency;
in response to determining that the risk score satisfies a score threshold, determining, using sensor data received from the one or more sensors at the second property, whether the second property is likely occupied by a person; and
in response to determining that the second property is likely occupied by a person:
determining, using at least some of the sensor data and a type of the emergency, a safe zone for the second property that indicates a physical location at which a risk of injury caused by the emergency is likely less than another location within a threshold distance of the second property;
determining, for presentation on a user interface, a pathway from a predicted location of the person to the safe zone; and
providing, to a device for presentation in the user interface, instructions to cause the device to present, in the user interface, a map of at least some of the geographic region including a) the predicted location of the person and the safe zone and b) the pathway from the predicted location of the person to a safe zone.

2. The computer-implemented method of claim 1, comprising:
determining an updated predicted location of the person;
determining whether the updated predicted location satisfies a distance threshold for the second property; and
in response to determining that the updated predicted location does not satisfy the distance threshold for the second property, changing a frequency of analysis of sensor data for the second property.

3. The computer-implemented method of claim 2, wherein:
determining whether the updated predicted location satisfies the distance threshold for the second property comprises determining whether the second property is unoccupied; and
changing the frequency of analysis of sensor data for the second property is responsive to determining that the second property is unoccupied.

4. The computer-implemented method of claim 1, wherein:
determining the safe zone comprises determining the safe zone that is outside of the geographic region.

5. The computer-implemented method of claim 1, wherein:
determining the safe zone comprises determining the safe zone that is in another subregion of the geographic region than the second, different subregion.

6. The computer-implemented method of claim 1, wherein:
receiving the sensor data comprises receiving, for at least one property in a third, different subregion of the geographic region, at least some of the sensor data; and
determining the safe zone comprises determining the safe zone in the third, different subregion of the geographic region.

7. The computer-implemented method of claim 1, wherein:
receiving the sensor data comprises receiving the sensor data for one or more properties a) in the first subregion of the geographic region and b) that do not include the second property.

8. The computer-implemented method of claim 1, wherein:
generating the risk score for the second, different subregion of the geographic region comprises generating the risk score for the second property; and
determining whether the second property is likely occupied by the person is responsive to determining that the risk score for the second property satisfies the score threshold.

9. The computer-implemented method of claim 1, comprising:
generating, for a third, different subregion of the geographic region, a second risk score; and
determining that the second risk score does not satisfy the score threshold, wherein determining the safe zone comprises determining the safe zone in the third, different subregion of the geographic region in response to determining that the second risk score does not satisfy the score threshold.

10. A system comprising one or more computers and one or more storage devices on which are stored instructions that are operable, when executed by the one or more computers, to cause the one or more computers to perform operations comprising:
receiving, for each of a plurality of properties in a geographic region and during an emergency in at least a first subregion of the geographic region that includes a first property, sensor data from one or more sensors located at the respective property, the plurality of properties including the first property in the first subregion of the geographic region and a second property in a second, different subregion of the geographic region;
receiving, from a first subsystem for the first property, a first request for assistance;
receiving, from a second subsystem for the second property, a second request for assistance;
determining, using first sensor data for the first subregion of the geographic region and second sensor data for the second, different subregion of the geographic region, a priority ranking in which the first request and the second request should be addressed; and
providing, to a device, instructions to cause the device to present the priority ranking in which the first request and the second request should be addressed.

11. The system of claim 10, the operations comprising:
determining, for one or more subregions of the geographic region and using the priority ranking, a frequency with which to analyze sensor data for the respective subregion of the geographic region; and
analyzing, for the one or more subregions of the geographic region and using the frequency, sensor data received from one or more properties in the respective region.

12. The system of claim 10, the operations comprising:
determining, for one or more subregions of the geographic region and using the priority ranking, a frequency with which to request sensor data for the respective subregion of the geographic region; and
communicating with one or more properties in a subregion of the one or more subregions using the frequency.

13. The system of claim 12, wherein determining the frequency comprises:
determining that a third property in the geographic region is unoccupied; and
determining to skip communicating with the third property in response to determining that the third property in the geographic region is unoccupied.

14. The system of claim 10, wherein:
the first sensor data for the first subregion of the geographic region comprises sensor data received from one or more first sensors at properties in the first subregion other than the first property; and
at least some of the second sensor data was received from one or more second sensors at the second property.

15. The system of claim 10, wherein providing the instructions comprises providing the instructions to cause the device to generate, in a user interface, a representation on a map of the priority ranking in which the first request and the second request should be addressed.

16. The system of claim 15, wherein the instructions cause the device to present a first user interface element for the first property or the second property that is occupied and a second, different user interface element for a third property in the geographic region that is unoccupied.

17. The system of claim 10, wherein determining the priority ranking in which the first request and the second request should be addressed uses the first sensor data, the second sensor data, a first assistance type for the first request, and a second assistance type for the second request.

18. The system of claim 10, the operations comprising:
determining, using data for the first request and the priority ranking, to provide, to another device for the first request, second instructions for addressing the first request;
providing, to the other device, the second instructions for addressing the first request, wherein:
providing the instructions comprises providing the instructions to cause the device to present the priority ranking that includes data indicating that instructions for the first request were provided to the other device.

19. The system of claim 18, wherein providing the second instructions for addressing the first request comprises:
determining, using at least some of the sensor data and a type of the emergency, a safe zone for the first property that indicates a physical location at which a risk of injury caused by the emergency is likely less than another location within a threshold distance of the first property;
determining, for presentation on a user interface, a pathway from a predicted location of a person for the first request to the safe zone; and
providing, to the other device for presentation in the user interface, the instructions to cause the other device to present, in the user interface, a map of at least some of the geographic region including a) the predicted location of the person and the safe zone and b) the pathway from the predicted location of the person to a safe zone.

20. One or more non-transitory computer storage media encoded with instructions that, when executed by one or more computers, cause the one or more computers to perform operations comprising:
receiving, for each of a plurality of properties in a geographic region and during an emergency in at least a first subregion of the geographic region that includes a first property, sensor data from one or more sensors located at the respective property, the plurality of properties including the first property in the first subregion of the geographic region and a second property in a second, different subregion of the geographic region;
generating, using the sensor data received from the sensors located at the pluralities of properties, a risk score i) for at least a second, different subregion of the geographic region ii) that indicates a likelihood that properties in the second, different subregion of the geographic region will be impacted by the emergency;
in response to determining that the risk score satisfies a score threshold, determining, using sensor data received from the one or more sensors at the second property, whether the second property is likely occupied by a person; and
in response to determining that the second property is likely occupied by a person:
determining, using at least some of the sensor data and a type of the emergency, a safe zone for the second property that indicates a physical location at which a risk of injury caused by the emergency is likely less than another location within a threshold distance of the second property;
determining, for presentation on a user interface, a pathway from a predicted location of the person to the safe zone; and
providing, to a device for presentation in the user interface, instructions to cause the device to present, in the user interface, a map of at least some of the geographic region including a) the predicted location of the person and the safe zone and b) the pathway from the predicted location of the person to a safe zone.
